(19) United States
(12) Patent Application Publication
(10) Pub. No.: US 2026/0135649 A1
(43) Pub. Date: May 14, 2026

(54) TRANSMISSION PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Qi HONG, Dongguan (CN); Gen LI, Dongguan (CN)

(73) Assignee: VIVO MOBILE COMMUNICATION CO., LTD., Dongguan (CN)

(21) Appl. No.: 19/032,391

(22) Filed: Jan. 20, 2025

Related U.S. Application Data
(63) Continuation of application No. PCT/CN2023/108340, filed on Jul. 20, 2023.

(30) Foreign Application Priority Data
Jul. 22, 2022 (CN) 202210870375.8

(51) Int. Cl. H04L 5/00; H04W 72/0446; H04W 76/28

(52) U.S. Cl. CPC H04L 5/0044; H04W 72/0446; H04W 76/28

(57) ABSTRACT

A transmission processing method and a terminal are provided. The transmission processing method includes: detecting, by the terminal through a first channel, first information sent by a network side device; and determining, by the terminal, a first transmission behavior of the terminal based on the detected first information. The first transmission behavior includes at least one of the following: performing or skipping uplink channel sending on a first resource; or performing or skipping downlink channel receiving on the first resource.

### CROSS-REFERENCE TO RELATED APPLICATIONS

This application is a continuation of International Application No. PCT/CN2023/108340, filed on Jul. 20, 2023, which claims priority to Chinese Patent Application No. 202210870375.8, filed on Jul. 22, 2022. The entire contents of each of the above-referenced applications are expressly incorporated herein by reference.

### TECHNICAL FIELD

This application belongs to the field of communication technologies, and in particular, to a transmission processing method and apparatus, a terminal, and a network side device.

### BACKGROUND

In a communication system, when a terminal is in an idle state, a Synchronization Signal and PBCH Block (SSB) of a cell needs to be measured for beam selection. In the related technology, a power saving mode is introduced for a network side device. Terminal transmission may be limited when the network side device is in the power saving mode. Therefore, in the related technology, there is a problem that reliability of terminal transmission is low when the power saving mode is introduced for the network side device.

### SUMMARY

Embodiments of this application provide a transmission processing method and apparatus, a terminal, and a network side device, which can solve the problem that reliability of terminal transmission is low when a power saving mode is introduced for the network side device.

According to a first aspect, a transmission processing method is provided, including:
detecting, by a terminal through a first channel, first information sent by a network side device; and
determining, by the terminal, a first transmission behavior of the terminal based on the detected first information, where
the first transmission behavior includes at least one of the following:
performing or skipping uplink channel sending on a first resource; and
performing or skipping downlink channel receiving on the first resource.

According to a second aspect, a transmission processing method is provided, including:
determining, by a network side device, whether to send first information to a terminal through a first channel, where
the first information is used to determine a first transmission behavior of the terminal, and the first transmission behavior includes at least one of the following:
performing or skipping uplink channel sending on a first resource; and
performing or skipping downlink channel receiving on the first resource.

According to a third aspect, a transmission processing apparatus is provided, including:
a first receiving module, configured to detect, through a first channel, first information sent by a network side device; and
a first determining module, configured to determine a first transmission behavior of the terminal based on the detected first information, where
the first transmission behavior includes at least one of the following:
performing or skipping uplink channel sending on a first resource; and
performing or skipping downlink channel receiving on the first resource.

According to a fourth aspect, a transmission processing apparatus is provided, including:
a second determining module, configured to determine whether to send first information to a terminal through a first channel, where
the first information is used to determine a first transmission behavior of the terminal, and the first transmission behavior includes at least one of the following:
performing or skipping uplink channel sending on a first resource; and
performing or skipping downlink channel receiving on the first resource.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface, where the communication interface is configured to detect, through a first channel, first information sent by a network side device; and the processor is configured to determine a first transmission behavior of the terminal based on the detected first information, where the first transmission behavior includes at least one of the following: performing or skipping uplink channel sending on a first resource; and performing or skipping downlink channel receiving on the first resource.

According to a seventh aspect, a network side device is provided. The network side device includes a processor and a memory, and the memory stores a program or an instruction that can be run on the processor, and the program or the instruction is executed by the processor to implement the steps of the method according to the second aspect.

According to an eighth aspect, a network side device is provided, including a processor and a communication interface, where the processor is configured to determine whether to send first information to a terminal through a first channel, where the first information is used to determine a first transmission behavior of the terminal, and the first transmission behavior includes at least one of the following: performing or skipping uplink channel sending on a first resource; and performing or skipping downlink channel receiving on the first resource.

According to a ninth aspect, a communication system is provided, including a terminal and a network side device. The terminal may be configured to perform the steps of the transmission processing method according to the first aspect, and the network side device may be configured to perform the steps of the transmission processing method according to the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided, where the chip includes a processor and a communication interface, the communication interface is coupled to the processor, and the processor is configured to run a program or an instruction, to implement the steps of the method according to the first aspect or the steps of the method according to the second aspect.

According to a twelfth aspect, a computer program/program product is provided, where the computer program/program product is stored in a storage medium, and the computer program/program product is executed by at least one processor to implement the steps of the method according to the first aspect or the steps of the method according to the second aspect.

In this embodiment of this application, the terminal determines the transmission behavior based on the first information sent by the network side device, so that the transmission error of the terminal can be effectively avoided after the network side device enters the power saving mode, and transmission reliability of the terminal is improved.

### BRIEF DESCRIPTION OF DRAWINGS

FIG. 1 is a schematic diagram of a network structure to which the embodiments of this application can be applied;

FIG. 2 is a flowchart of a transmission processing method according to some embodiments of this application;

FIG. 3 is a flowchart of another transmission processing method according to some embodiments of this application;

FIG. 4 is a structural diagram of a transmission processing apparatus according to some embodiments of this application;

FIG. 5 is a structural diagram of another transmission processing apparatus according to some embodiments of this application;

FIG. 6 is a schematic diagram of a structure of a communication device according to some embodiments of this application;

FIG. 7 is a schematic diagram of a structure of a terminal according to some embodiments of this application; and

FIG. 8 is a schematic diagram of a structure of a network side device according to some embodiments of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

For ease of understanding, some content involved in the embodiments of this application is described below.

### 1. Downlink Wake-Up Signal (DL WUS)

In a 5G system, to further improve power saving performance of a UE, a WUS based on Physical Downlink Control Channel (PDCCH) is introduced. A function of the WUS is to notify the terminal whether the PDCCH needs to be monitored in onDuration of a Discontinuous Reception (DRX). In a case that there is no data, the terminal may not need to monitor the PDCCH in the onDuration. In other words, the terminal may be in a sleep state in an entire DRX long cycle, thereby further saving power.

The WUS is a type of Downlink Control Information (DCI), and is shortly referred to as DCI with Cyclic Redundancy Check (CRC) scrambled by Power Saving (PS)-Radio Network Temporary Identifier (RNTI) (DCI with CRC scrambled by PS-RNTI (DCP)). The PS-RNTI is an RNTI that is allocated by a network to the terminal and that is used for a power saving characteristic, and the DCI scrambled by the RNTI carries a wake-up/sleep indication of the network for the UE. The terminal determines, based on the indication, whether to enable an onDuration timer and whether to monitor the PDCCH in a next DRX cycle.

### 2. PDCCH

The PDCCH is a downlink control channel, and carries DCI of a Physical Uplink Shared Channel (PUSCH) and a Physical Downlink Shared Channel (PDSCH). In LTE, the PDCCH occupies all the bandwidth in frequency domain and first 1 to 3 symbols of each subframe in time domain. In NR, if the PDCCH continues to occupy all the bandwidth as in LTE, it is undoubtedly a waste of resources, and it may put high demands on the terminal, which is not conducive to reducing terminal costs. Therefore, the PDCCH in NR may be within a Bandwidth Part (BWP), and does not occupy some fixed slots in time domain. In NR, one PDCCH schedules one PDSCH so far. A PDCCH time-frequency resource in NR is mainly determined by a Control Resource Set (CORESET) and a Search Space (SS).

### 3. Control Resource Set

The CORESET solves the problem of an existence range of the PDCCH, such as a time domain length and a frequency domain range. A system bandwidth of NR is very large (at a maximum of 400 M), and if a static configuration mode of LTE is followed (occupying the whole system bandwidth), complexity of blind detection may be greatly increased. Therefore, NR adopts a configurable CORESET, and a time domain length and a frequency domain range of the CORESET may be configured by using system information or a dedicated RRC message.

### 4. Search Space

The search space solves the problem of how the terminal searches. There is a similar concept in LTE, and its purpose is to reduce the complexity of blind detection of the terminal as much as possible. Different from LTE, the search space in NR aims at a CORESET, and NR may configure different search spaces for different UEs, that is, different blind detection manners (such as a monitoring cycle, a start location of a monitored symbol, and the like) are configured for different terminals. Therefore, complexity of blind detection of terminals can be further reduced.

### 5. Downlink Control Information

The UE learns of its own configuration of CORESET and search space, and finds a PDCCH sent to the UE, thus solving content carried on a PDCCH channel, that is, the downlink control information.

The DCI has different formats, as shown in the following table:

| DCI format | Purpose |
|---|---|
| 0-0 | Schedule a PUSCH in a cell and back off DCI |
| | (unrelated to RRC) |
| 0-1 | Schedule a PUSCH in a cell (unrelated to RRC) |
| 1-0 | Schedule a PDSCH in a cell and back off DCI |
| 1-1 | Schedule a PDSCH in a cell |
| 2-0 | Notify a group of terminals of a slot format, and a |
| | length is configured by RRC with a maximum of |
| | 128 bits |
| 2-1 | Notify a group of terminals that transmission |
| | cannot be performed on some time-frequency |
| | resources, a length is configured by RRC with a |
| | maximum of 126 bits, and each Preemption |
| | Indication (PI) is 14 bits |
| 2-2 | Physical Uplink Control Channel (PUCCH) and |
| | Transmit Power Control (TPC) signaling of a |
| | PUSCH |
| 2-3 | TPC signaling of an SRS |

Different DCI formats include different content. For example, DCI 1-0 may include the following content:
1. Distinguishing sign: 1 bit;
2. Frequency domain resource allocation domain;
3. Time domain resource allocation domain; 4 bits;
4. Mapping from a Virtual Resource Block (VRB) to a Physical Resource Block (PRB): 1 bit;
5. Modulation and coding scheme: 5 bits;
6. New data indication: 1 bit;
7. Redundant version: 2 bits;
8. Hybrid Automatic Repeat reQuest (HARQ) process indication; 4 bits;
9. Downward distribution indication: 2 bits;
10. PUCCH power control signaling: 2 bits;
11. PUCCH resource indication: 3 bits; and
12. HARQ feedback timing indication: 3 bits.

With reference to the accompanying drawings, a transmission processing method provided in the embodiments of this application is described in detail by using some embodiments and application scenarios thereof.

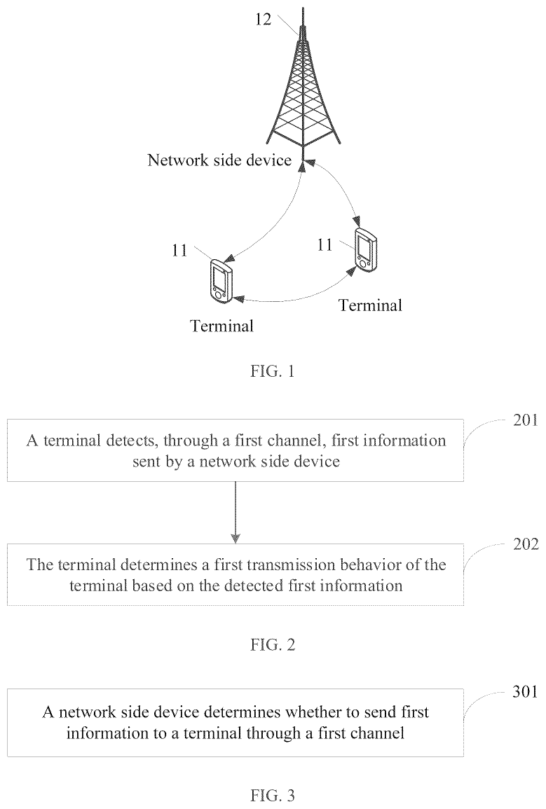

Refer to FIG. 2, an embodiment of this application provides a transmission processing method. As shown in FIG. 2, the transmission processing method includes the following steps.

Step 201: A terminal detects, through a first channel, first information sent by a network side device.

Step 202: The terminal determines a first transmission behavior of the terminal based on the detected first information.

The first transmission behavior includes at least one of the following:
performing or skipping uplink channel sending on a first resource; and
performing or skipping downlink channel receiving on the first resource.

In this embodiment of this application, the first channel may be a PDCCH, and the network side device may send the first information to the terminal through the first channel. After receiving the first information, the terminal may determine the first transmission behavior based on the first information, for example, performing or skipping uplink channel sending on the first resource, and performing or skipping downlink channel receiving on the first resource.

It should be understood that after the network side device enters a power saving mode, the following cases may exist:
Case 1: The network side device disables downlink channel sending and uplink channel receiving;
Case 2: The network side device disables only downlink channel sending; and
Case 3: The network side device disables only uplink channel receiving.

The network side device may control a transmission behavior of the terminal by using the first information based on a state of entering the power saving mode. For example, for Case 1, the terminal may skip uplink channel sending and downlink channel receiving; for Case 2, the terminal skips downlink channel receiving; and for Case 3, the terminal may skip uplink channel sending. This can avoid a transmission error of the terminal after the network side device enters the power saving mode. In addition, in a case that the network side device does not disable uplink channel receiving, the terminal may also perform uplink channel sending, and in a case that the network side device does not disable downlink channel sending, the terminal may perform downlink channel receiving, which can ensure a normal transmission function in a case of avoiding a transmission error, thereby improving transmission reliability.

It should be noted that the first resource may be understood as a time unit, and may be one or more slots, or one or more symbols. In some embodiments, the terminal may determine to skip uplink channel sending on a part of the first resource, perform uplink channel sending on a part of the first resource, skip downlink channel receiving on a part of the first resource, and perform downlink channel receiving on a part of the first resource for a period of time.

In this embodiment of this application, the terminal determines the transmission behavior based on the first information sent by the network side device, so that the transmission error of the terminal can be effectively avoided after the network side device enters the power saving mode, and transmission reliability of the terminal is improved.

In some embodiments, before that a terminal detects, through a first channel, first information sent by a network side device, the method further includes:
sending, by the terminal, a target uplink signal to the network side device on a second resource, where the target uplink signal is used to indicate at least one of the following:
requesting to perform or skip uplink channel sending on the first resource; and
requesting to perform or skip downlink channel receiving on the first resource.

In this embodiment of this application, the terminal may request a corresponding transmission behavior from the network side device based on a state of the terminal. For example, in some embodiments, if the terminal is about to enter the power saving mode, or it is determined to enter the power saving mode, the terminal may request to skip uplink channel sending on the first resource and/or request to skip downlink channel receiving on the first resource. In this way, the network side device may determine whether to enter the power saving mode based on the request of the terminal, thereby reducing power consumption of the network side device.

In some embodiments, it is assumed that the terminal needs to perform a transmission operation, the terminal may request to perform uplink channel sending on the first resource and/or request to perform downlink channel receiving on the first resource, so that the network side device may exit or not enter the power saving mode, to meet a transmission requirement of the terminal.

It should be noted that the network side device may accept or reject the request of the terminal, and feed back by using the first information, which can ensure consistency of understanding for the transmission behavior between the terminal and the network side device, and reduce a probability of the transmission error of the terminal.

In some embodiments, the second resource may be periodic or aperiodic. If the second resource is periodic, the cycle may be configured by the network side device, and if the second resource is aperiodic, the cycle may be triggered by the network side device. Further, when the second resource is periodic, a cycle may include a plurality of opportunities for uplink sending. For example, a time window is set, the terminal performs a plurality of times of uplink sending based on a configuration of the network side device (no more than N times at most) in the time window, and N may be configured by the network side device.

In some embodiments, information configured by the network side device for the terminal may be informed to the terminal by using a downlink channel or RRC configuration information, where the downlink channel may include an SSB, a Master Information Block (MIB), a System Information Block (SIB), a PDCCH, a PDSCH, or the like.

In some embodiments, the second resource meets at least one of the following:
the second resource is a resource configured by the network side device; and
the second resource is a cell specific or terminal specific (UE specific) resource.

In some embodiments, the target uplink signal may be a dedicated WUS, and may also be a signal such as a Configured Grant (CG), a Scheduling Request (SR), or a PUCCH in the related technology.

In some embodiments, an SR or CG signal that is located in on-duration and that is in a last cycle may be used as a current WUS.

In some embodiments, the first channel meets at least one of the following:
the first channel is a PDCCH scrambled by a first RNTI, and the first RNTI is an RNTI dedicated to first information indication; and
the first channel is a terminal specific PDCCH, a group common PDCCH, or a cell specific PDCCH.

In some embodiments, the first information meets any one of the following:
the first information is carried by using first DCI, a preset bit in a first indicator field, or a second indicator field in the first DCI is used to indicate the first information, the preset bit is a reusable bit in the first indicator field, and the second indicator field is a new indicator field; and
the first information is carried by using second DCI, and the second DCI is in a new format.

In this embodiment of this application, the first DCI may be understood as DCI already defined in the related technology. In other words, a format of the first DCI may be a DCI format already defined in the related technology, such as DCI 1_0 or 1_1. The first indicator field is an indicator field defined by a protocol in the related technology, and the second indicator field may be understood as a newly defined indicator field. The preset bit may be understood as an existing bit in the first indicator field, that is, bits in some indicator fields may not be used in the PDCCH, and thus may be reused.

In some embodiments, a time domain location of a detection resource of the first channel includes at least one of the following:
a periodic time domain location configured by the network side device;
at least one time domain location in periodic time domain locations pre-configured by the network side device that is after a first moment and that is nearest to the first moment, where the first moment is after the terminal sends the target uplink signal, and the first moment is separated from a completion time of sending the target uplink signal by first preset duration;
a time domain location that is before a second moment and that is separated from the second moment by an interval greater than second preset duration, where the second moment is a start moment or an end moment of duration of DRX or duration of Discontinuous Transmission (DTX) configured by the network side device; and
a time domain location that is after a third moment and that is separated from the third moment by an interval greater than third preset duration, where the third moment is a start moment or an end moment of a time domain location in which the terminal sends the target uplink signal.

The time domain location that is before the second moment and that is separated from the second moment by an interval greater than the second preset duration may be understood as a fixed time before the duration of DRX or the duration of DTX. For example, if the duration of DRX is in slot 3 and slot 4, then the PDCCH can be detected on slot 1.

For example, lengths of the first preset duration, the second preset duration, and the third preset duration may be set according to actual requirements, and in some embodiments, the first preset duration, the second preset duration, and the third preset duration may be predefined by a protocol or configured by a network device.

In some embodiments, a time domain location of the first resource includes at least one of the following:
a time domain location of duration of at least one DRX or DTX that is separated from a fourth moment by an interval greater than fourth preset duration and that is after and nearest to the fourth moment, where the fourth moment is a start moment or an end moment of the first channel;
a time domain location of duration of at least one DRX or DTX that is separated from a fifth moment by an interval greater than fifth preset duration and that is after and nearest to the fifth moment, where the fifth moment is a start moment or an end moment of the second resource, and the second resource is used for the terminal to send the target uplink signal; and
a time domain location between a start moment or an end moment of a start time domain location and a sixth moment, where the sixth moment is after the start time domain location, and the sixth moment is separated from the start time domain location by sixth preset duration.

In this embodiment of this application, lengths of the fourth preset duration, the fifth preset duration, and the sixth preset duration may be set according to actual requirements, and in some embodiments, the fourth preset duration, the fifth preset duration, and the sixth preset duration may be predefined by a protocol or configured by a network device.

It should be understood that the start moment or the end moment of the first channel may be understood as a start moment or an end moment of a time domain resource of the first channel, or a start moment or an end moment of a time unit (such as a slot or a symbol) in which the time domain resource of the first channel is located.

In some embodiments, the sixth preset duration may be understood as an offset time, that is, a time domain location separated from the start time domain location by an offset time is the time domain location of the first resource.

In some embodiments, there may be one or more start time domain locations, for example, the start time domain locations include slot 1, slot 4, and slot 7. The sixth preset duration may be 2 slots, and the time domain location of the first resource may include slot 1, slot 2, slot 4, slot 5, slot 7, and slot 8.

In some embodiments, the start time domain location is determined based on at least one of the following:
a seventh moment;
an eighth moment;
a start time domain location of at least one target cycle that is after and nearest to the seventh moment, where the target cycle is a DRX cycle or a DTX cycle; and
a start time domain location of at least one target cycle that is after and nearest to the eighth moment, where the target cycle is a DRX cycle or a DTX cycle, where
the seventh moment is after the start moment or the end moment of the first channel, and the seventh moment is separated from the start moment or the end moment of the first channel by seventh preset duration; and the eighth moment is after the start moment or the end moment of the second resource, and the eighth moment is separated from the start moment or the end moment of the second resource by eighth preset duration.

In this embodiment of this application, as for that the start time domain location is determined based on the seventh moment, the time domain location of the first resource may be understood as including an interval of an offset time after the start moment or the end moment of the first channel, and the offset time is predefined by a protocol, configured by the network side device, or explicitly indicated by the first channel.

As for that the start time domain location is determined based on the eighth moment, the time domain location of the first resource may be understood as including an interval of an offset time after the start moment or the end moment of the second resource, and the offset time is predefined by a protocol, configured by the network side device, or explicitly indicated by the first channel.

In some embodiments, the duration is specified by a protocol, configured by the network side device, or indicated by first information of the first channel, which is not further limited herein.

In some embodiments, the first information is used to indicate at least one of the following:
whether the network side device performs or skips uplink channel receiving on the first resource;
whether the network side device performs or skips downlink channel sending on the first resource;
feedback information of the network side device to the target uplink signal sent by the terminal on the second resource;
time domain indication information of the first resource;
frequency domain indication information of the first resource;
activating or deactivating sending of a preset uplink channel;
activating or deactivating receiving of a preset downlink channel;
a type of an uplink channel on which the terminal performs or skips sending; and
a type of a downlink channel on which the terminal performs or skips receiving.

In this embodiment of this application, the time domain indication information of the first resource may include at least one of the following:
a start time domain location of the first resource;
duration of the first resource; and
a quantity of pieces of DRX on duration or DTX on duration included in the first resource.

In some embodiments, the method further includes:
performing, by the terminal, a second transmission behavior in a case that the first information is not detected, where
the second transmission behavior includes at least one of the following:
performing or skipping uplink channel sending; and
performing or skipping downlink channel receiving.

It should be understood that in this embodiment of this application, the second transmission behavior may be a default transmission behavior specified by a protocol or configured by the network side device, and may also be a corresponding transmission behavior requested by the terminal by using the target uplink signal, which is not further limited herein.

To better understand this application, a description will be given below through some embodiments.

In some embodiments, it may be considered that the terminal confirms a resource for performing/skipping uplink channel sending and/or downlink channel receiving after directly receiving the first information.

For a terminal side, the terminal detects, through the first channel, the first information sent by the network side device, to confirm the first resource for performing/skipping uplink channel sending and/or downlink channel receiving. The first information includes at least one of following:
whether the network side device performs or skips uplink channel receiving on the first resource;
whether the network side device performs or skips downlink channel sending on the first resource;
feedback information of the network side device to the target uplink signal sent by the terminal on the second resource;
time domain indication information of the first resource;
frequency domain indication information of the first resource;
activating or deactivating sending of a preset uplink channel;
activating or deactivating receiving of a preset downlink channel or signal (for example, a CG signal, a Sounding Reference Signal (SRS), and the like);
a type of an uplink channel on which the terminal performs or skips sending; and
a type of a downlink channel on which the terminal performs or skips receiving.

The time domain location of the first resource is determined by using at least one of the following:
a time domain location/time domain locations of one or more pieces of DRX/DTX on-duration that is/are after the start time or the end time of the first channel or after the start time or the end time of the first channel for a time interval, and that is/are nearest to the start time or the end time of the first channel; and
duration starting from one or more start time domain locations.

In some embodiments, the start time domain location is obtained by using at least one of the following:
an interval of an offset time after the start time or the end time of the first channel, and the offset time is predefined by a protocol, configured by the network side device, or explicitly indicated by the first channel;
an interval of an offset time after the start time or the end time of the second resource, and the offset time is predefined by a protocol, configured by the network side device, or explicitly indicated by the first channel;
a start time domain location/start time domain locations of one or more DRX/DTX cycles that is/are after the start time or the end time of the first channel or after the start time or the end time of the first channel for a time interval, and that is/are nearest to the start time or the end time of the first channel; and
a start time domain location/start time domain locations of one or more DRX/DTX cycles that is/are after the start time or the end time of the second resource or after the start time or the end time of the second resource for a time interval, and that is/are nearest to the start time or the end time of the second resource.

In some embodiments, the duration is predefined by a protocol, configured by the network side device, or indicated by the first information of the first channel.

In some embodiments, the first channel may be a PDCCH. The first channel may meet at least one of following:
the first channel is a PDCCH scrambled by a first RNTI, and the first RNTI is an RNTI dedicated to first information indication; and
the first channel is a terminal specific PDCCH, a group common PDCCH, or a cell specific PDCCH.

In some embodiments, the first information meets any one of the following:
the first information is carried by using first DCI, a preset bit in a first indicator field, or a second indicator field in the first DCI is used to indicate the first information, the preset bit is a reusable bit in the first indicator field, and the second indicator field is a new indicator field; and
the first information is carried by using second DCI, and the second DCI is in a new format.

In some embodiments, when the first channel or the first information is not detected by the terminal, the terminal may perform the second transmission behavior. The second transmission behavior includes at least one of the following:
performing or skipping uplink channel sending; and
performing or skipping downlink channel receiving.

For the network side device side, the network side device or the protocol predefines a location of the first channel and sends the first information in the location. The location of the first channel is obtained by using one of the following:
a periodic time domain location configured by the network side device;
a time domain location that is before a start time of DTX/DRX on duration configured by the network side device for a second time interval; and
a time domain location that starts from a time domain location in which the terminal sends an uplink signal for a third time interval.

In some embodiments, the first time interval, the second time interval, or the third time interval is predefined by a protocol or configured by the network side device.

In some embodiments, it is considered that the terminal receives the first information of the network side device after sending the uplink signal, to confirm a resource for performing/skipping uplink channel sending and/or downlink channel receiving.

For the terminal side, the terminal sends the target uplink signal on the second resource, and detects, through the first channel, the first information sent by the network side device, to confirm the first resource for performing/skipping uplink channel sending and/or downlink channel receiving.

In some embodiments, the second resource is configured by the network side device, and may be periodic or aperiodic. If the second resource is periodic, the cycle may be configured by the network side device. If the second resource is aperiodic, the second resource may be triggered by the network side device; and if the second resource is periodic, there may be a plurality of opportunities to send the target uplink signal in a cycle, for example, a time window is set, and the terminal may send the target uplink signal for a plurality of times based on a network configuration within the time window (no more than N times at most), where N may be configured by the network side device. In some embodiments, the configuration information may be notified to the UE by the network side device by using a downlink channel or RRC configuration information. The downlink channel includes an SSB, an MIB, an SIB, a PDCCH, a PDSCH, and the like.

In some embodiments, the second resource may be cell specific or UE specific.

In some embodiments, the target uplink signal may be a dedicated WUS, and may also be a signal such as a CG, an SR, or a PUCCH in the related technology.

In some embodiments, an SR or CG signal that is located in on-duration and that is in a last cycle may be used as a current WUS.

In some embodiments, the target uplink signal may include the following information: requesting to perform or skip uplink channel sending and/or downlink channel receiving on the first resource.

In addition to the information in the foregoing embodiment (the embodiment in which it is considered that the terminal confirms the resource for performing/skipping uplink channel sending and/or downlink channel receiving after directly receiving the first information), the first information may further include a feedback for the target uplink signal sent on the second resource.

For the network side device side, the network side device pre-configures or it is specified by a protocol, a location of the second resource and a location of the first resource. In addition to the location defined in the foregoing embodiment (the embodiment in which it is considered that the terminal confirms the resource for performing/skipping uplink channel sending and/or downlink channel receiving after directly receiving the first information), the location of the first resource may further include: a time domain location/time domain locations of one or more pieces of DRX/DTX on-duration that is/are after the start time or the end time of the second resource or after the start time or the end time of the second resource for a time interval, and that is/are nearest to the start time or the end time of the second resource.

Refer to FIG. 3, an embodiment of this application further provides a transmission processing method. As shown in FIG. 3, the transmission processing method includes the following steps.

Step 301: A network side device determines whether to send first information to a terminal through a first channel.

The first information is used to determine a first transmission behavior of the terminal, and the first transmission behavior includes at least one of the following:
performing or skipping uplink channel sending on a first resource; and
performing or skipping downlink channel receiving on the first resource.

In some embodiments, the network side device may send the first information on the first channel when determining to send the first information to the terminal through the first channel.

In some embodiments, before that a network side device determines whether to send first information to a terminal through a first channel, the method further includes:
receiving, by the network side device on a second resource, a target uplink signal sent by the terminal, where the target uplink signal is used to indicate at least one of the following:
requesting to perform or skip uplink channel sending on the first resource; and
requesting to perform or skip downlink channel receiving on the first resource.

In some embodiments, the second resource meets at least one of the following:
the second resource is a resource configured by the network side device; and
the second resource is a cell specific or terminal specific resource.

In some embodiments, the first channel meets at least one of the following:
the first channel is a PDCCH scrambled by a first RNTI, and the first RNTI is an RNTI dedicated to first information indication; and
the first channel is a terminal specific PDCCH, a group common PDCCH, or a cell specific PDCCH.

In some embodiments, the first information meets any one of the following:
the first information is carried by using first DCI, a preset bit in a first indicator field, or a second indicator field in the first DCI is used to indicate the first information, the preset bit is a reusable bit in the first indicator field, and the second indicator field is a new indicator field; and
the first information is carried by using second DCI, and the second DCI is in a new format.

In some embodiments, a time domain location of a sending resource of the first channel includes at least one of the following:
a periodic time domain location configured by the network side device;
at least one time domain location in periodic time domain locations pre-configured by the network side device that is after a first moment and that is nearest to the first moment, where the first moment is after the terminal sends the target uplink signal, and is separated from a completion time of sending the target uplink signal by first preset duration;
a time domain location that is before a second moment and that is separated from the second moment by an interval greater than second preset duration, where the second moment is a start moment or an end moment of duration of DRX or duration of DTX configured by the network side device; and
a time domain location that is after a third moment and that is separated from the third moment by an interval greater than third preset duration, where the third moment is a start moment or an end moment of a time domain location in which the terminal sends the target uplink signal.

In some embodiments, a time domain location of the first resource includes at least one of the following:
a time domain location of duration of at least one DRX or DTX that is separated from a fourth moment by an interval greater than fourth preset duration and that is after and nearest to the fourth moment, where the fourth moment is a start moment or an end moment of the first channel;
a time domain location of duration of at least one DRX or DTX that is separated from a fifth moment by an interval greater than fifth preset duration and that is after and nearest to the fifth moment, where the fifth moment is a start moment or an end moment of the second resource, and the second resource is used for the terminal to send the target uplink signal; and
a time domain location between a start moment or an end moment of a start time domain location and a sixth moment, where the sixth moment is after the start time domain location, and the sixth moment is separated from the start time domain location by sixth preset duration.

In some embodiments, the start time domain location is determined based on at least one of the following:
a seventh moment;
an eighth moment;
a start time domain location of at least one target cycle that is after and nearest to the seventh moment, where the target cycle is a DRX cycle or a DTX cycle; and
a start time domain location of at least one target cycle that is after and nearest to the eighth moment, where the target cycle is a DRX cycle or a DTX cycle, where
the seventh moment is after the start moment or the end moment of the first channel, and the seventh moment is separated from the start moment or the end moment of the first channel by seventh preset duration; and the eighth moment is after the start moment or the end moment of the second resource, and the eighth moment is separated from the start moment or the end moment of the second resource by eighth preset duration.

In some embodiments, the first information is used to indicate at least one of the following:
whether the network side device performs or skips uplink channel receiving on the first resource;
whether the network side device performs or skips downlink channel sending on the first resource;
feedback information of the network side device to the target uplink signal sent by the terminal on the second resource;
time domain indication information of the first resource;
frequency domain indication information of the first resource;
activating or deactivating sending of a preset uplink channel;
activating or deactivating receiving of a preset downlink channel;
a type of an uplink channel on which the terminal performs or skips sending; and
a type of a downlink channel on which the terminal performs or skips receiving.

The transmission processing method provided in this embodiment of this application may be executed by a transmission processing apparatus. In the embodiments of this application, the transmission processing apparatus according to an embodiment of this application is described by using an example in which the transmission processing apparatus performs the transmission processing method.

Refer to FIG. 4, an embodiment of this application further provides a transmission processing apparatus. As shown in FIG. 4, the transmission processing apparatus 400 includes:
a first receiving module 401, configured to detect, through a first channel, first information sent by a network side device; and
a first determining module 402, configured to determine a first transmission behavior of the terminal based on the detected first information, where
the first transmission behavior includes at least one of the following:
performing or skipping uplink channel sending on a first resource; and
performing or skipping downlink channel receiving on the first resource.

In some embodiments, the transmission processing apparatus 400 further includes:
a first sending module, configured to send a target uplink signal to the network side device on a second resource, where the target uplink signal is used to indicate at least one of the following:
requesting to perform or skip uplink channel sending on the first resource; and
requesting to perform or skip downlink channel receiving on the first resource.

In some embodiments, the second resource meets at least one of the following:
the second resource is a resource configured by the network side device; and
the second resource is a cell specific or terminal specific resource.

In some embodiments, the first channel meets at least one of the following:
the first channel is a PDCCH scrambled by a first RNTI, and the first RNTI is an RNTI dedicated to first information indication; and
the first channel is a terminal specific PDCCH, a group common PDCCH, or a cell specific PDCCH.

In some embodiments, the first information meets any one of the following:
the first information is carried by using first DCI, a preset bit in a first indicator field, or a second indicator field in the first DCI is used to indicate the first information, the preset bit is a reusable bit in the first indicator field, and the second indicator field is a new indicator field; and
the first information is carried by using second DCI, and the second DCI is in a new format.

In some embodiments, a time domain location of a detection resource of the first channel includes at least one of the following:
a periodic time domain location configured by the network side device;
at least one time domain location in periodic time domain locations pre-configured by the network side device that is after a first moment and that is nearest to the first moment, where the first moment is after the terminal sends the target uplink signal, and the first moment is separated from a completion time of sending the target uplink signal by first preset duration;
a time domain location that is before a second moment and that is separated from the second moment by an interval greater than second preset duration, where the second moment is a start moment or an end moment of duration of DRX or duration of DTX configured by the network side device; and
a time domain location that is after a third moment and that is separated from the third moment by an interval greater than third preset duration, where the third moment is a start moment or an end moment of a time domain location in which the terminal sends the target uplink signal.

In some embodiments, a time domain location of the first resource includes at least one of the following:
a time domain location of duration of at least one DRX or DTX that is separated from a fourth moment by an interval greater than fourth preset duration and that is after and nearest to the fourth moment, where the fourth moment is a start moment or an end moment of the first channel;
a time domain location of duration of at least one DRX or DTX that is separated from a fifth moment by an interval greater than fifth preset duration and that is after and nearest to the fifth moment, where the fifth moment is a start moment or an end moment of the second resource, and the second resource is used for the terminal to send the target uplink signal; and
a time domain location between a start moment or an end moment of a start time domain location and a sixth moment, where the sixth moment is after the start time domain location, and the sixth moment is separated from the start time domain location by sixth preset duration.

In some embodiments, the start time domain location is determined based on at least one of the following:
a seventh moment;
an eighth moment;
a start time domain location of at least one target cycle that is after and nearest to the seventh moment, where the target cycle is a DRX cycle or a DTX cycle; and
a start time domain location of at least one target cycle that is after and nearest to the eighth moment, where the target cycle is a DRX cycle or a DTX cycle, where
the seventh moment is after the start moment or the end moment of the first channel, and the seventh moment is separated from the start moment or the end moment of the first channel by seventh preset duration; and the eighth moment is after the start moment or the end moment of the second resource, and the eighth moment is separated from the start moment or the end moment of the second resource by eighth preset duration.

In some embodiments, the first information is used to indicate at least one of the following:
whether the network side device performs or skips uplink channel receiving on the first resource;
whether the network side device performs or skips downlink channel sending on the first resource;
feedback information of the network side device to the target uplink signal sent by the terminal on the second resource;
time domain indication information of the first resource;
frequency domain indication information of the first resource;
activating or deactivating sending of a preset uplink channel;
activating or deactivating receiving of a preset downlink channel;
a type of an uplink channel on which the terminal performs or skips sending; and
a type of a downlink channel on which the terminal performs or skips receiving.

In some embodiments, the transmission processing apparatus 400 further includes: an execution module, configured to perform a second transmission behavior in a case that the first information is not detected, where
the second transmission behavior includes at least one of the following:
performing or skipping uplink channel sending; and
performing or skipping downlink channel receiving.

It should be noted that the transmission processing apparatus provided in the embodiments of this application can implement the processes implemented in the method embodiment of FIG. 2, and achieve a same technical effect. To avoid repetition, details are not described herein again.

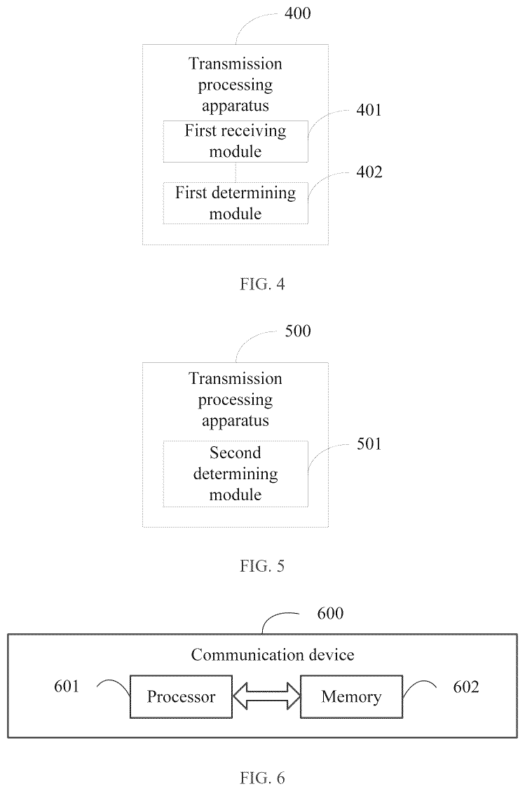

Refer to FIG. 5, an embodiment of this application further provides a transmission processing apparatus. As shown in FIG. 5, the transmission processing apparatus 500 includes:
a second determining module 501, configured to determine whether to send first information to a terminal through a first channel, where
the first information is used to determine a first transmission behavior of the terminal, and the first transmission behavior includes at least one of the following:
performing or skipping uplink channel sending on a first resource; and
performing or skipping downlink channel receiving on the first resource.

In some embodiments, the transmission processing apparatus 500 further includes:
a second receiving module, configured to receive, on a second resource, a target uplink signal sent by the terminal, where the target uplink signal is used to indicate at least one of the following:
requesting to perform or skip uplink channel sending on the first resource; and
requesting to perform or skip downlink channel receiving on the first resource.

In some embodiments, the second resource meets at least one of the following:
the second resource is a resource configured by the network side device; and
the second resource is a cell specific or terminal specific resource.

In some embodiments, the first channel meets at least one of the following:
the first channel is a PDCCH scrambled by a first RNTI, and the first RNTI is an RNTI dedicated to first information indication; and
the first channel is a terminal specific PDCCH, a group common PDCCH, or a cell specific PDCCH.

In some embodiments, the first information meets any one of the following:
the first information is carried by using first DCI, a preset bit in a first indicator field, or a second indicator field in the first DCI is used to indicate the first information, the preset bit is a reusable bit in the first indicator field, and the second indicator field is a new indicator field; and
the first information is carried by using second DCI, and the second DCI is in a new format.

In some embodiments, a time domain location of a sending resource of the first channel includes at least one of the following:
a periodic time domain location configured by the network side device;
at least one time domain location in periodic time domain locations pre-configured by the network side device that is after a first moment and that is nearest to the first moment, where the first moment is after the terminal sends the target uplink signal, and is separated from a completion time of sending the target uplink signal by first preset duration;
a time domain location that is before a second moment and that is separated from the second moment by an interval greater than second preset duration, where the second moment is a start moment or an end moment of duration of DRX or duration of DTX configured by the network side device; and
a time domain location that is after a third moment and that is separated from the third moment by an interval greater than third preset duration, where the third moment is a start moment or an end moment of a time domain location in which the terminal sends the target uplink signal.

In some embodiments, a time domain location of the first resource includes at least one of the following:
a time domain location of duration of at least one DRX or DTX that is separated from a fourth moment by an interval greater than fourth preset duration and that is after and nearest to the fourth moment, where the fourth moment is a start moment or an end moment of the first channel;
a time domain location of duration of at least one DRX or DTX that is separated from a fifth moment by an interval greater than fifth preset duration and that is after and nearest to the fifth moment, where the fifth moment is a start moment or an end moment of the second resource, and the second resource is used for the terminal to send the target uplink signal; and
a time domain location between a start moment or an end moment of a start time domain location and a sixth moment, where the sixth moment is after the start time domain location, and the sixth moment is separated from the start time domain location by sixth preset duration.

In some embodiments, the start time domain location is determined based on at least one of the following:
a seventh moment;
an eighth moment;
a start time domain location of at least one target cycle that is after and nearest to the seventh moment, where the target cycle is a DRX cycle or a DTX cycle; and
a start time domain location of at least one target cycle that is after and nearest to the eighth moment, where the target cycle is a DRX cycle or a DTX cycle, where
the seventh moment is after the start moment or the end moment of the first channel, and the seventh moment is separated from the start moment or the end moment of the first channel by seventh preset duration; and the eighth moment is after the start moment or the end moment of the second resource, and the eighth moment is separated from the start moment or the end moment of the second resource by eighth preset duration.

In some embodiments, the first information is used to indicate at least one of the following:
whether the network side device performs or skips uplink channel receiving on the first resource;
whether the network side device performs or skips downlink channel sending on the first resource;
feedback information of the network side device to the target uplink signal sent by the terminal on the second resource;
time domain indication information of the first resource;
frequency domain indication information of the first resource;
activating or deactivating sending of a preset uplink channel;
activating or deactivating receiving of a preset downlink channel;
a type of an uplink channel on which the terminal performs or skips sending; and
a type of a downlink channel on which the terminal performs or skips receiving.

The transmission processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The transmission processing apparatus provided in the embodiments of this application can implement the processes implemented in the method embodiment of FIG. 3, and achieve a same technical effect. To avoid repetition, details are not described herein again.

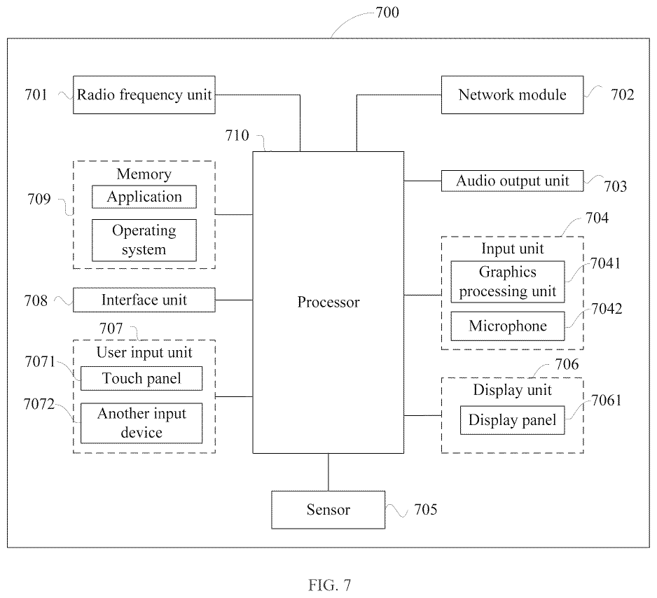

For example, as shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is executed by the processor 601 to implement the steps of the foregoing transmission processing method embodiment on a terminal side. When the communication device 600 is a network side device, the program or the instruction is executed by the processor 601 to implement the steps of the foregoing transmission processing method embodiment on a network side device side, and a same technical effect can be achieved. To avoid repetition, details are not described herein again.

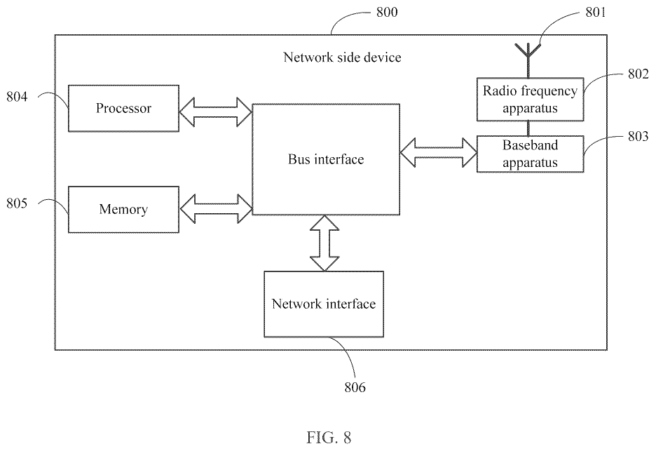

An embodiment of this application further provides a terminal, including a processor and a communication interface, where the communication interface is configured to detect, through a first channel, first information sent by a network side device; and the processor is configured to determine a first transmission behavior of the terminal based on the detected first information, where the first transmission behavior includes at least one of the following: performing or skipping uplink channel sending on a first resource; and performing or skipping downlink channel receiving on the first resource. The terminal embodiment is corresponding to the method embodiment on the terminal side, each implementation process and implementation of the method embodiment can be applied to the terminal embodiment, and a same technical effect can be achieved. For example, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a Graphics Processing Unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 709 in this embodiment of this application includes but is not limited to these memories and any memory of another proper type.

The processor 710 may include one or more processing units. In some embodiments, an application processor and a modem processor are integrated into the processor 710. The application processor mainly processes an operating system, a user interface, an application, or the like. The modem processor mainly processes a wireless communication signal, for example, a baseband processor. It may be understood that, in some alternative embodiments, the modem processor may not be integrated into the processor 710.

The radio frequency unit 701 is configured to detect, through a first channel, first information sent by a network side device; and
the processor 710 is configured to determine a first transmission behavior of the terminal based on the detected first information, where
the first transmission behavior includes at least one of the following:
performing or skipping uplink channel sending on a first resource; and
performing or skipping downlink channel receiving on the first resource.

In this embodiment of this application, the terminal determines the transmission behavior based on the first information sent by the network side device, so that the transmission error of the terminal can be effectively avoided after the network side device enters the power saving mode, and transmission reliability of the terminal is improved.

The terminal 700 provided in this embodiment of this application can implement the steps of the transmission processing method embodiment on the terminal side, and a same technical effect can be achieved. Details are not described herein again.

An embodiment of this application further provides a network side device, including a processor and a communication interface, where the processor is configured to determine whether to send first information to a terminal through a first channel, where the first information is used to determine a first transmission behavior of the terminal, and the first transmission behavior includes at least one of the following: performing or skipping uplink channel sending on a first resource; and performing or skipping downlink channel receiving on the first resource. This network side device embodiment is corresponding to the foregoing method embodiment of the network side device. Each implementation process and implementation of the foregoing method embodiment may be applicable to this network side device embodiment, and a same technical effect can be achieved.

An embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The network side device may further include a network interface 806, and the interface is, for example, a Common Public Radio Interface (CPRI).

The network side device 800 in this embodiment of the present disclosure further includes an instruction or a program that is stored in the memory 805 and that can be run on the processor 804. The processor 804 invokes the instruction or the program in the memory 805 to perform the method performed by the modules shown in FIG. 5, and achieve a same technical effect. To avoid repetition, details are not described herein again.

An embodiment of this application further provides a readable storage medium. The readable storage medium stores a program or an instruction. When the program or the instruction is executed by a processor, the processes in the foregoing transmission processing method embodiments are implemented, with the same technical effects achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application still provides a chip. The chip includes a processor and a communication interface, and the communication interface is coupled to the processor. The processor is configured to run a program or an instruction, to implement various processes of the foregoing embodiments of the transmission processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes of the foregoing transmission processing method embodiment, and a same technical effect can be achieved. To avoid repetition, details are not described herein again.

An embodiment of this application further provides a communication system, including a terminal and a network side device. The terminal is configured to execute the processes of the foregoing method embodiments in FIG. 2 and on the terminal side, the network side device is configured to execute the processes of the foregoing method embodiments in FIG. 3 and on the network side device side, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. A transmission processing method, comprising:
detecting, by a terminal through a first channel, first information sent by a network side device; and
determining, by the terminal, a first transmission behavior of the terminal based on the detected first information, wherein
the first transmission behavior comprises at least one of the following:
performing or skipping uplink channel sending on a first resource; or
performing or skipping downlink channel receiving on the first resource.

2. The transmission processing method according to claim 1, wherein before detecting, by the terminal through the first channel, the first information sent by the network side device, the method further comprises:
sending, by the terminal, a target uplink signal to the network side device on a second resource, wherein the target uplink signal is used to indicate at least one of the following:
requesting to perform or skip uplink channel sending on the first resource; or
requesting to perform or skip downlink channel receiving on the first resource.

3. The transmission processing method according to claim 2, wherein the second resource meets at least one of the following:
the second resource is a resource configured by the network side device; or
the second resource is a cell specific or terminal specific resource.

4. The transmission processing method according to claim 1, wherein the first channel meets at least one of the following:
the first channel is a Physical Downlink Control Channel (PDCCH) scrambled by a first Radio Network Temporary Identifier (RNTI), and the first RNTI is an RNTI dedicated to first information indication; or
the first channel is a terminal specific PDCCH, a group common PDCCH, or a cell specific PDCCH.

5. The transmission processing method according to claim 4, wherein the first information meets any one of the following:
the first information is carried by using first Downlink Control Information (DCI), a preset bit in a first indicator field, or a second indicator field in the first DCI is used to indicate the first information, wherein the preset bit is a reusable bit in the first indicator field, and the second indicator field is a new indicator field; or
the first information is carried by using second DCI, and the second DCI is in a new format.

6. The transmission processing method according to claim 1, wherein a time domain location of a detection resource of the first channel comprises at least one of the following:
a periodic time domain location configured by the network side device;
at least one time domain location in periodic time domain locations pre-configured by the network side device that is after a first moment and that is nearest to the first moment, wherein the first moment is after the terminal sends the target uplink signal, and the first moment is separated from a completion time of sending the target uplink signal by first preset duration;
a time domain location that is before a second moment and that is separated from the second moment by an interval greater than second preset duration, wherein the second moment is a start moment or an end moment of duration of Discontinuous Reception (DRX) or duration of Discontinuous Transmission (DTX) configured by the network side device; or
a time domain location that is after a third moment and that is separated from the third moment by an interval greater than third preset duration, wherein the third moment is a start moment or an end moment of a time domain location in which the terminal sends the target uplink signal.

7. The transmission processing method according to claim 1, wherein a time domain location of the first resource comprises at least one of the following:
a time domain location of duration of at least one Discontinuous Reception (DRX) or Discontinuous Transmission (DTX) that is separated from a fourth moment by an interval greater than fourth preset duration and that is after and nearest to the fourth moment, wherein the fourth moment is a start moment or an end moment of the first channel;
a time domain location of duration of at least one DRX or DTX that is separated from a fifth moment by an interval greater than fifth preset duration and that is after and nearest to the fifth moment, wherein the fifth moment is a start moment or an end moment of the second resource, and the second resource is used for the terminal to send the target uplink signal; or
a time domain location between a start moment or an end moment of a start time domain location and a sixth moment, wherein the sixth moment is after the start time domain location, and the sixth moment is separated from the start time domain location by sixth preset duration.

8. The transmission processing method according to claim 7, wherein the start time domain location is determined based on at least one of the following:
a seventh moment;
an eighth moment;
a start time domain location of at least one target cycle that is after and nearest to the seventh moment, wherein the target cycle is a DRX cycle or a DTX cycle; or
a start time domain location of at least one target cycle that is after and nearest to the eighth moment, wherein the target cycle is a DRX cycle or a DTX cycle, wherein
the seventh moment is after the start moment or the end moment of the first channel, and the seventh moment is separated from the start moment or the end moment of the first channel by seventh preset duration; and the eighth moment is after the start moment or the end moment of the second resource, and the eighth moment is separated from the start moment or the end moment of the second resource by eighth preset duration.

9. The transmission processing method according to claim 1, wherein the first indication information is used to indicate at least one of the following:
whether the network side device performs or skips uplink channel receiving on the first resource;
whether the network side device performs or skips downlink channel sending on the first resource;
feedback information of the network side device to the target uplink signal sent by the terminal on the second resource;
time domain indication information of the first resource;
frequency domain indication information of the first resource;
activating or deactivating sending of a preset uplink channel;
activating or deactivating receiving of a preset downlink channel;
a type of an uplink channel on which the terminal performs or skips sending; or
a type of a downlink channel on which the terminal performs or skips receiving.

10. The transmission processing method according to claim 1, further comprising:
performing, by the terminal, a second transmission behavior when the first information is not detected, wherein
the second transmission behavior comprises at least one of the following:
performing or skipping uplink channel sending; or
performing or skipping downlink channel receiving.

11. A terminal, comprising: a processor; and a memory having a computer program or an instruction stored thereon, wherein the computer program or the instruction, when executed by the processor, causes the processor to implement operations comprising:
detecting, through a first channel, first information sent by a network side device; and
determining a first transmission behavior of the processor based on the detected first information, wherein
the first transmission behavior comprises at least one of the following:
performing or skipping uplink channel sending on a first resource; or
performing or skipping downlink channel receiving on the first resource.

12. The terminal according to claim 11, wherein before detecting, through the first channel, the first information sent by the network side device, the operations further comprise:
sending a target uplink signal to the network side device on a second resource, wherein the target uplink signal is used to indicate at least one of the following:
requesting to perform or skip uplink channel sending on the first resource; or
requesting to perform or skip downlink channel receiving on the first resource.

13. The terminal according to claim 12, wherein the second resource meets at least one of the following:
the second resource is a resource configured by the network side device; or
the second resource is a cell specific or terminal specific resource.

14. The terminal according to claim 11, wherein the first channel meets at least one of the following:
the first channel is a Physical Downlink Control Channel (PDCCH) scrambled by a first Radio Network Temporary Identifier (RNTI), and the first RNTI is an RNTI dedicated to first information indication; or
the first channel is a terminal specific PDCCH, a group common PDCCH, or a cell specific PDCCH.

15. The terminal according to claim 14, wherein the first information meets any one of the following:
the first information is carried by using first Downlink Control Information (DCI), a preset bit in a first indicator field, or a second indicator field in the first DCI is used to indicate the first information, wherein the preset bit is a reusable bit in the first indicator field, and the second indicator field is a new indicator field; or
the first information is carried by using second DCI, and the second DCI is in a new format.

16. The terminal according to claim 11, wherein a time domain location of a detection resource of the first channel comprises at least one of the following:
a periodic time domain location configured by the network side device;
at least one time domain location in periodic time domain locations pre-configured by the network side device that is after a first moment and that is nearest to the first moment, wherein the first moment is after the processor sends the target uplink signal, and the first moment is separated from a completion time of sending the target uplink signal by first preset duration;
a time domain location that is before a second moment and that is separated from the second moment by an interval greater than second preset duration, wherein the second moment is a start moment or an end moment of duration of Discontinuous Reception (DRX) or duration of Discontinuous Transmission (DTX) configured by the network side device; or
a time domain location that is after a third moment and that is separated from the third moment by an interval greater than third preset duration, wherein the third moment is a start moment or an end moment of a time domain location in which the processor sends the target uplink signal.

17. The terminal according to claim 11, wherein a time domain location of the first resource comprises at least one of the following:
a time domain location of duration of at least one Discontinuous Reception (DRX) or Discontinuous Transmission (DTX) that is separated from a fourth moment by an interval greater than fourth preset duration and that is after and nearest to the fourth moment, wherein the fourth moment is a start moment or an end moment of the first channel;
a time domain location of duration of at least one DRX or DTX that is separated from a fifth moment by an interval greater than fifth preset duration and that is after and nearest to the fifth moment, wherein the fifth moment is a start moment or an end moment of the second resource, and the second resource is used for the processor to send the target uplink signal; or
a time domain location between a start moment or an end moment of a start time domain location and a sixth moment, wherein the sixth moment is after the start time domain location, and the sixth moment is separated from the start time domain location by sixth preset duration.

18. The terminal according to claim 17, wherein the start time domain location is determined based on at least one of the following:
a seventh moment;
an eighth moment;
a start time domain location of at least one target cycle that is after and nearest to the seventh moment, wherein the target cycle is a DRX cycle or a DTX cycle; or
a start time domain location of at least one target cycle that is after and nearest to the eighth moment, wherein the target cycle is a DRX cycle or a DTX cycle, wherein
the seventh moment is after the start moment or the end moment of the first channel, and the seventh moment is separated from the start moment or the end moment of the first channel by seventh preset duration; and the eighth moment is after the start moment or the end moment of the second resource, and the eighth moment is separated from the start moment or the end moment of the second resource by eighth preset duration.

19. The terminal according to claim 11, wherein the first indication information is used to indicate at least one of the following:
whether the network side device performs or skips uplink channel receiving on the first resource;
whether the network side device performs or skips downlink channel sending on the first resource;
feedback information of the network side device to the target uplink signal sent by the processor on the second resource;
time domain indication information of the first resource;
frequency domain indication information of the first resource;
activating or deactivating sending of a preset uplink channel;
activating or deactivating receiving of a preset downlink channel;
a type of an uplink channel on which the processor performs or skips sending; or
a type of a downlink channel on which the processor performs or skips receiving.

20. A non-transitory computer readable storage medium storing instructions that, when executed by a processor, causes the processor to perform operations comprising:
detecting, through a first channel, first information sent by a network side device; and
determining a first transmission behavior of the processor based on the detected first information, wherein
the first transmission behavior comprises at least one of the following:
performing or skipping uplink channel sending on a first resource; or
performing or skipping downlink channel receiving on the first resource.
